(19) United States
(12) Patent Application Publication
(10) Pub. No.: US 2026/0236037 A1
(43) Pub. Date: Aug. 13, 2026

(54) AUTOMATIC TOWING SYSTEM AND OPERATION METHOD OF THE SAME

(71) Applicant: HON HAI PRECISION INDUSTRY CO., LTD., New Taipei City (TW)

(72) Inventor: Chun I SU, New Taipei City (TW)

(21) Appl. No.: 19/182,581

(22) Filed: Apr. 17, 2025

(30) Foreign Application Priority Data
Feb. 8, 2025 (TW) 114104767

(51) Int. Cl. G05D 1/667; G05D 105/28

(52) U.S. Cl. CPC G05D 1/667; G05D 2105/28

(57) ABSTRACT

An automatic towing system includes a towing robot and a towing truck. The towing robot is configured to move a vehicle. The towing robot includes a camera and a towing arm. The camera is configured to detect a position of the vehicle and an environment of the vehicle. The towing truck is configured to engage with the towing arm of the towing robot.

### CROSS - REFERENCE TO RELATED APPLICATION

This application claims priority to Taiwan Application Serial Number 114104767, filed February 08, 2025, which is herein incorporated by reference in its entirety.

### BACKGROUND

### Field of Invention

The present invention relates to an automatic towing system and an operation method of an automatic towing system.

### Description of Related Art

In the current method of handling illegally parked vehicles, it is necessary to rely on human resource to park the towing truck in front of or behind the illegal vehicle. Therefore, there needs to be enough space around the vehicle so that the tow arm of the towing truck can be placed under the front wheel or the rear wheel of the illegally parked vehicle. In addition, the towing truck needs to tow the illegal parked vehicle to the specified parking space of the storage area and lower the vehicle to the specified location. The owner of the illegally parked vehicle needs to enter the specified location of the storage area to pick up the vehicle and drive the vehicle out of the storage area.

In view of this, how to provide a system and method that can solve the problem of insufficient space in front and behind the vehicle and simplify the procedure of moving the vehicle into or out of the storage area is still one of the goals that urgently need to be developed.

### SUMMARY

The invention provides an automatic towing system.

In one embodiment, an automatic towing system includes a towing robot and a towing truck. The towing robot is configured to move a vehicle. The towing robot includes a camera and a towing arm. The camera is configured to detect a position of the vehicle and an environment of the vehicle. The towing truck is configured to engage with the towing arm of the towing robot.

Another aspect of the present disclosure is an operation method of an automatic towing system.

In one embodiment, the operation method of the automatic towing system includes lifting up and moving the first vehicle by a towing robot; detecting a position of a towing truck by a camera and a controller of the towing robot; and engaging the towing robot with the a traction arm towing truck through a tow arm of the towing robot.

In the aforementioned embodiments, the towing robot can automatically move to the bottom of the illegally parked vehicle and lift up the vehicle, and move the vehicle out of the illegal parking area. Therefore, there is no need to reserve space in the front and the rear of the location of the vehicle for the towing truck to perform the vehicle towing, which can solve the problem of insufficient space. There is no need to use human effort to drive the vehicle into the parking space of the vehicle storage area, which can simplify the human resource and the process of moving the vehicle into the vehicle storage area. The owner does not need to enter the vehicle storage area to drive the vehicle out, which can simplify the human resource and the process of moving the vehicle out of the vehicle storage area.

### BRIEF DESCRIPTION OF THE DRAWINGS

The invention can be more fully understood by reading the following detailed description of the embodiment, with reference made to the accompanying drawings as follows:

FIG. 1 is a schematic of an automatic towing system according to one embodiment of the present embodiment.

FIG. 2 is a schematic of an application scenario of the automatic towing system according to one embodiment of the present embodiment.

FIG. 3A is a top view of the towing robot according to one embodiment of the present embodiment.

FIG. 3B is a side view of the towing robot in FIG. 3A.

FIG. 4 is a schematic of engagement between the towing truck and the towing robot according to one embodiment of the present embodiment.

FIG. 5 is a schematic of positioning points of the towing truck according to one embodiment of the present embodiment.

FIG. 6 is a flow chart of an operation method of an automatic towing system according to one embodiment of the present embodiment.

FIG. 7 is a schematic of an intermediate step of the operation method of the automatic towing system in FIG. 6.

FIG. 8 is a schematic of an intermediate step of the operation method of the automatic towing system in FIG. 6.

FIG. 9 is a schematic of an intermediate step of the operation method of the automatic towing system in FIG. 6.

### DETAILED DESCRIPTION

Reference will now be made in detail to the present embodiments of the invention, examples of which are illustrated in the accompanying drawings. Wherever possible, the same reference numbers are used in the drawings and the description to refer to the same or like parts.

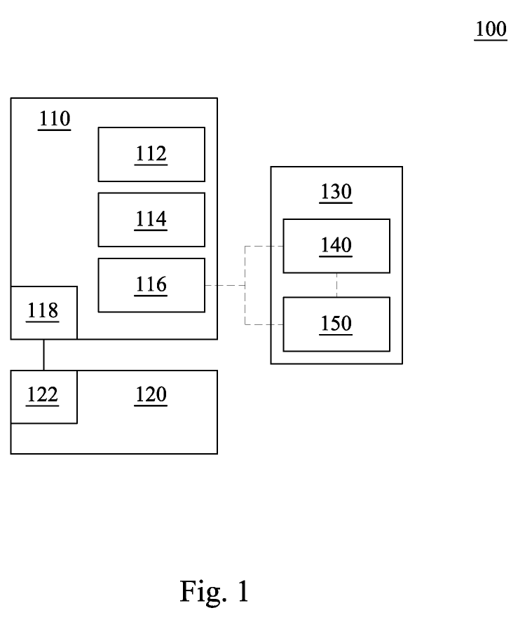

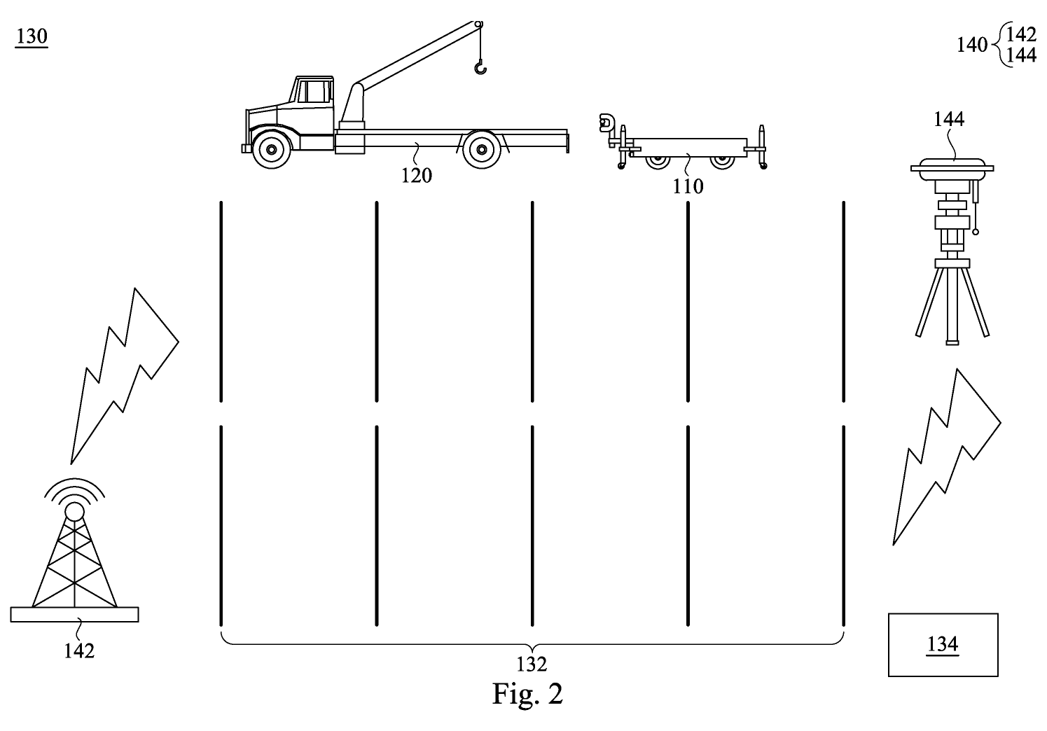

FIG. 1 is a schematic of an automatic towing system 100 according to one embodiment of the present embodiment. FIG. 2 is a schematic of an application scenario of the automatic towing system 100 according to one embodiment of the present embodiment. The automatic towing system 100 includes a towing robot 110, a towing truck 120, a vehicle storage area 130, a global positioning system 140, and a data processing module 150. The global positioning system 140 is disposed in the vehicle storage area 130. The global positioning system 140 is electrically connected to the data processing module 150. The towing robot 110 is electrically connected to the global positioning system 140 and the data processing module 150. The towing robot 110 is physically connected to the towing truck 120 so as to perform vehicle towing.

The automatic towing system 100 disclosed in the present disclosure can move an illegally parked vehicle 160 to a designated parking space in the vehicle storage area 130, or move it out of a designated parking space. There is no need for manual driving and no need for the vehicle owner to enter the storage area.

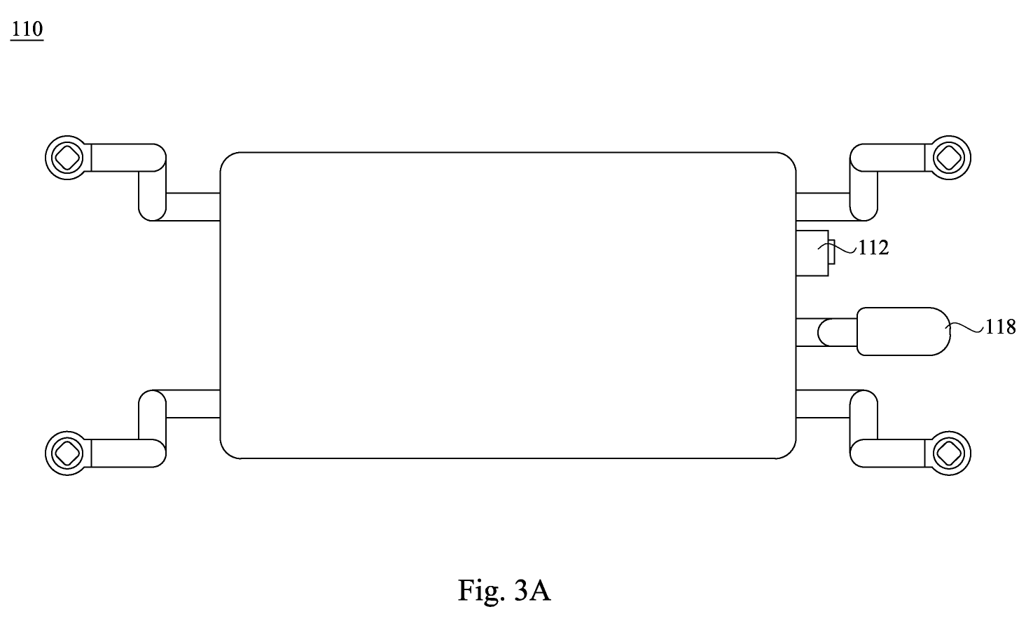

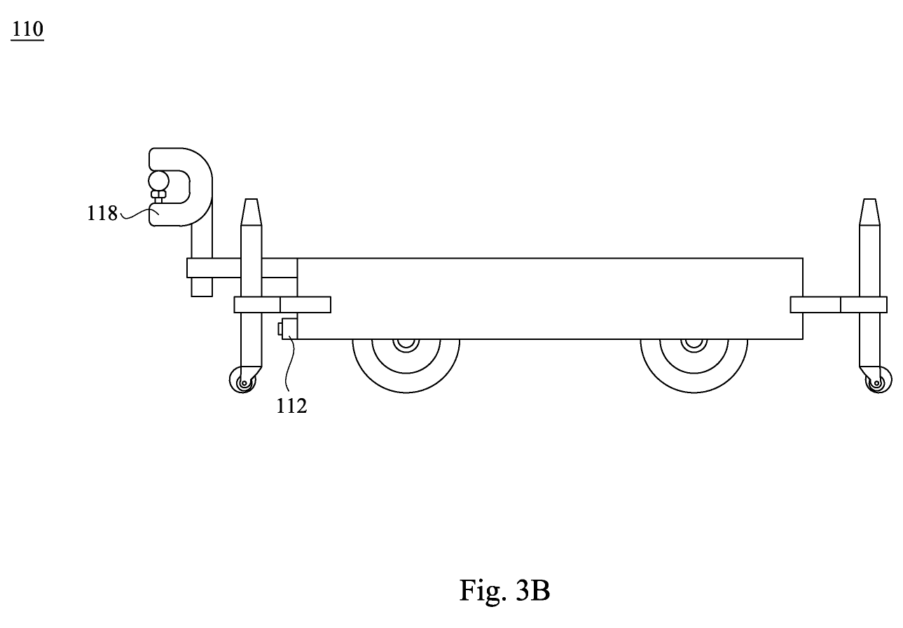

FIG. 3A is a top view of the towing robot 110 according to one embodiment of the present embodiment. FIG. 3B is a side view of the towing robot 110 in FIG. 3A. Reference is made to FIG. 1, FIG. 3A, and FIG. 3B. The towing robot 110 includes a camera 112, a controller 114, a wireless communication module 116, and a towing arm 118. The camera 112 is configured to detect the location of the vehicle and the environment in which the vehicle is located. The towing robot 110 can automatically move to the bottom of the illegally parked vehicle 160 to lift up the vehicle 160, and move the vehicle 160 out of the illegally parked area. When moving the vehicle 160 out of the illegal parking area, the towing robot 110 only needs to move under the vehicle 160. Therefore, there is no need to reserve space in the front and the rear of the location of the vehicle for the towing truck 120 to perform the vehicle towing.

Reference is made to FIG. 1. The towing robot 110 includes the wireless communication module 116 which is configured to communicate with the global positioning system 140 and the data processing module 150. The controller 114 of the towing robot 110 has an autonomous driving technology, which can be used to move illegally parked vehicles into or out of a designated parking space to avoid collisions with other vehicles.

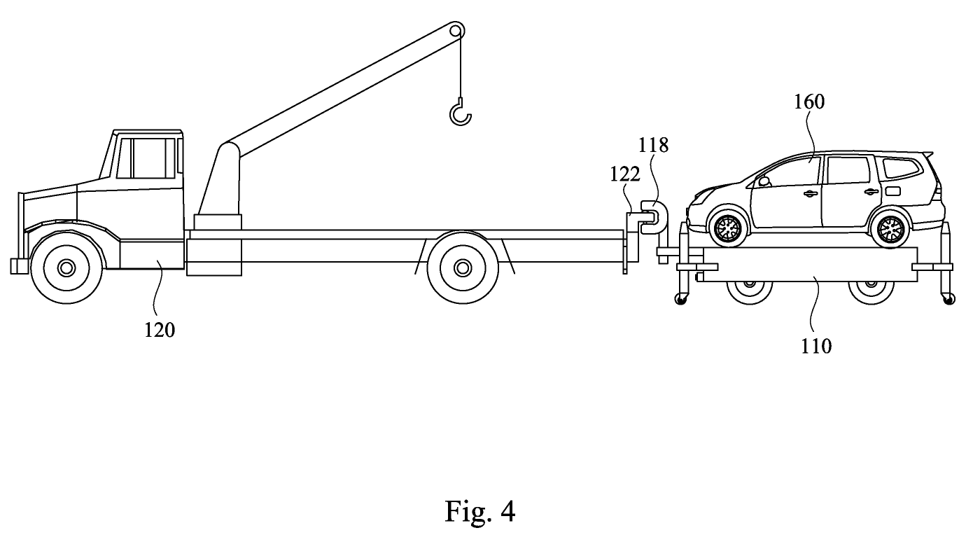

FIG. 4 is a schematic of engagement between the towing truck 120 and the towing robot 110 according to one embodiment of the present embodiment. The towing truck 120 includes a traction arm 122 configured to engage with the towing arm 118 of the towing robot 110. The position of the traction arm 122 of the towing truck 120 is analyzed through the camera 112 and the controller 114 after the towing robot 110 lifts up the vehicle 160, and the engagement is performed.

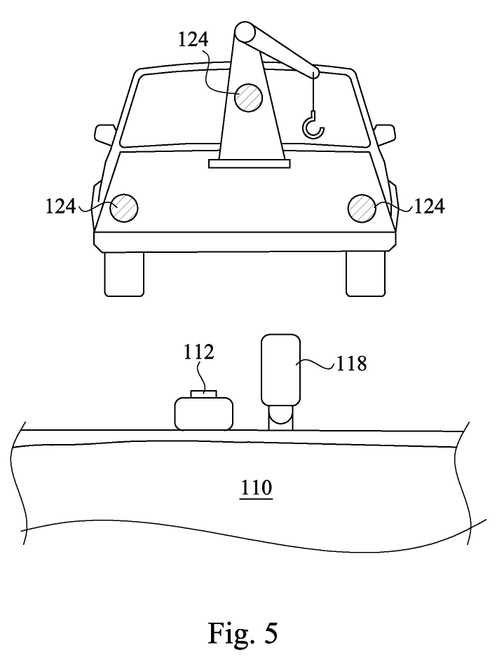

FIG. 5 is a schematic of positioning points of the towing truck 120 according to one embodiment of the present embodiment. The towing truck 120 includes multiple positioning points 124, and the camera 112 of the towing robot 110 is configured to detect the positioning points 124. The controller 114 of the towing robot 110 is configured to analyze the distance between the towing truck 120 and the towing robot 110 according to the coordinate of the positioning points 124 detected by the camera 112.

Reference is made to FIG. 2, the vehicle storage area 130 includes a standby area 134 for the towing robot 110 to be parked therein. The global positioning system 140 includes a differential GPS base station 142 and a mobile station 144 configured to measure the coordinates of the parking spaces 132. The data processing module 150 is configured to record the coordinates of the parking spaces 132 measured by the global positioning system 140 and send the coordinates of the parking spaces 132 to the towing robot 110. The wireless communication module 116 of the towing robot 110 is configured to transmit parking information to the data processing module 150. The data processing module 150 is also configured to transmit vehicle pickup information to the towing robot 110.

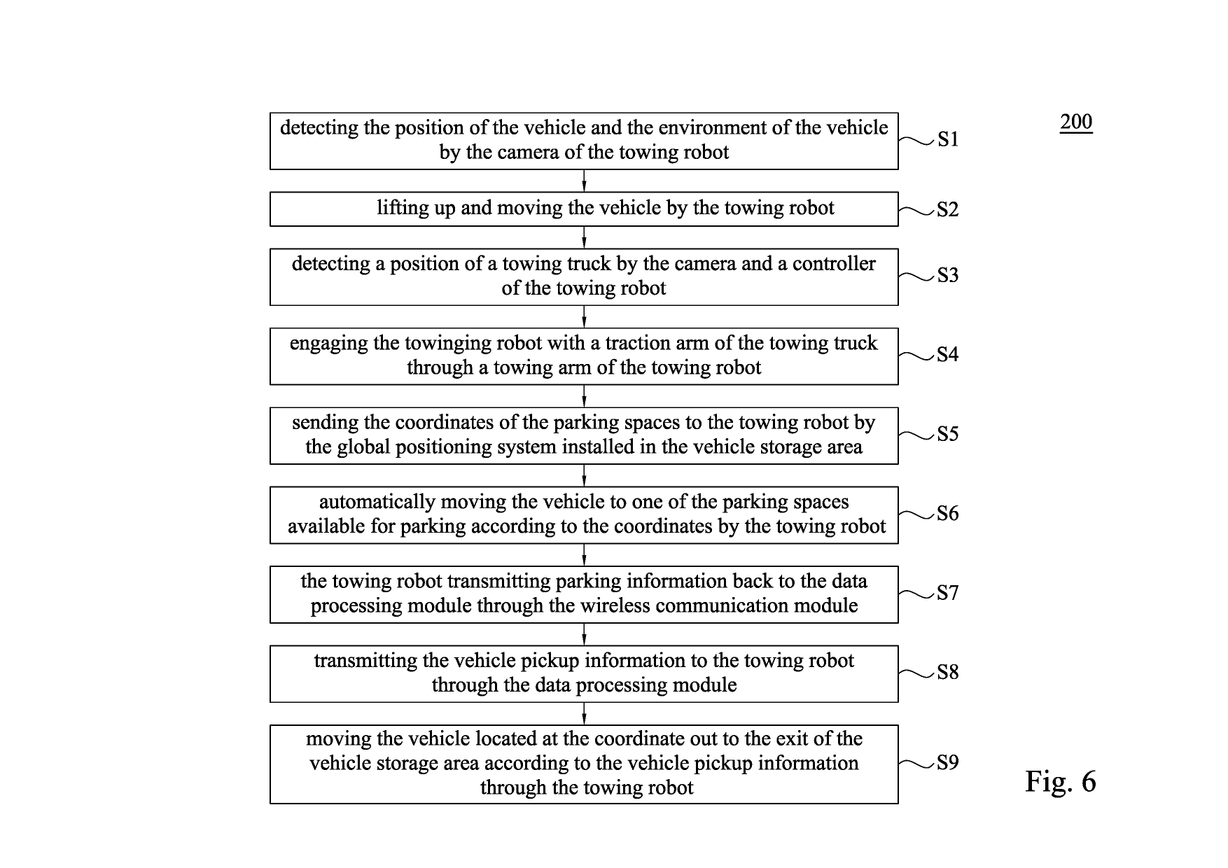

FIG. 6 is a flow chart of an operation method 200 of an automatic towing system 100 according to one embodiment of the present embodiment. The operation method 200 begins with step S1, where the position of the vehicle 160 and the environment of the vehicle 160 are detected by the camera 112 of the towing robot 110. When a parking illegal event occurs, the towing robot 110 is placed next to the parking area. The camera 112 of the towing robot 110 can detect the space around the vehicle 160 and automatically determine how to move the vehicle 160.

The operation method 200 continues to step S2, where the towing robot 110 lifts up the vehicle 160 and moves the vehicle 160. The towing robot 110 moves to the bottom of the vehicle 160 at proper position and angle according to the detection result, and lifts up the vehicle 160 and moves it out of the illegal parking area. In this step, the towing robot 110 can move the vehicle 160 out after the towing robot 110 moves to the bottom of the vehicle 160, and the towing truck 120 does not directly move the vehicle 160. Therefore, there is no need to consider the problem of insufficient space in the front and the area space around the vehicle 160, which can increase the convenience and safety of operation and avoid damage to the vehicle 160.

Reference is made to FIG. 5 and FIG. 6. The operation method 200 continues to step S3, where the position of the towing truck 120 is detected by the camera 112 and the controller 114 of the towing robot 110. In the present embodiment, the towing truck 120 has three positioning points 124 for the camera 112 to recognize the position of the towing truck 120. The controller 114 analyzes the image of the positioning points 124 captured by the camera 112 to obtain an image coordinate. Since the actual distances between the three positioning points 124 are fixed and known, the pixel coordinates are converted into normalized image coordinate based on the pixel data when the camera 112 is capturing, and the pixel distances between the positioning points 124 can be obtained. Then, the angle relationship and actual distance between the three positioning points 124 are solved through triangulation, and the actual distance between the towing truck 120 and the towing robot 110 can be calculated. The towing robot 110 moves toward the towing truck 120 according to the calculated distance. When the towing robot 110 is moving, the step of calculating the distance between the towing truck 120 and the towing robot 110 is continuously executed.

Reference is made to FIG. 4 and FIG. 6. The operation method 200 continues to step S4, where the towing arm 118 of the towing robot 110 is engaged with the traction arm 122 of the towing truck 120. When the towing robot 110 moves and approaches the rear of the towing truck 120, the camera 112 and the controller 114 of the towing robot 110 can analyze the position of the traction arm 122. After the towing robot 110 locates the position of the traction arm 122, the towing robot 110 can automatically extend the towing arm 118 to connect with the traction arm 122. The staff can drive the towing truck 120 to guide the vehicle 160 and the towing robot 110 from the illegal parking area to the vehicle storage area 130.

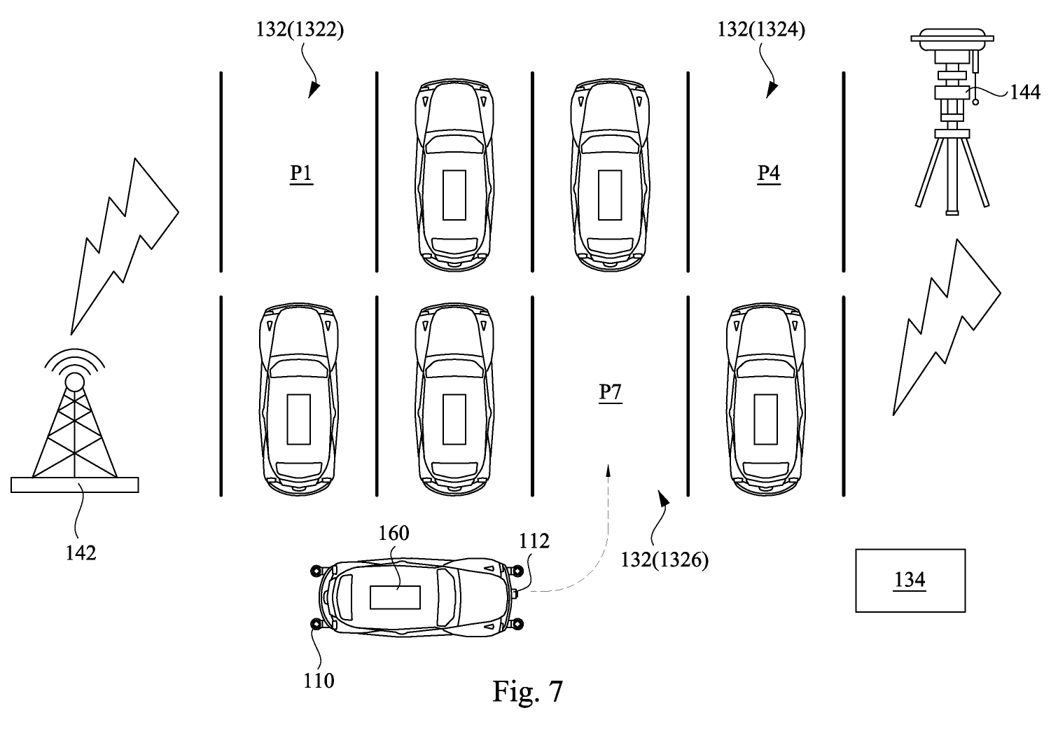

Reference is made to FIG. 6 and FIG. 7. FIG. 7 is a schematic of an intermediate step of the operation method 200 of the automatic towing system 100 in FIG. 6. The operation method 200 continues to step S5, where the coordinates of the parking spaces 132 are sent to the towing robot 110 by the global positioning system 140 installed in the vehicle storage area 130. When the illegally parked vehicle 160 is towed to the vehicle storage area 130, the towing truck 120 and the towing robot 110 are disengaged. The mobile station 144 receives the differential correction signal sent by the differential GPS base station 142 to obtain the coordinates of the parking spaces 132. The global positioning system 140 sends the coordinates of the parking spaces 132 available for parking to the towing robot 110, such as the parking spaces 1322, 1324, 1326 represented by the coordinates P1, P4, and P7. The towing robot 110 can receive the signal through a wireless communication module 116, such as Bluetooth.

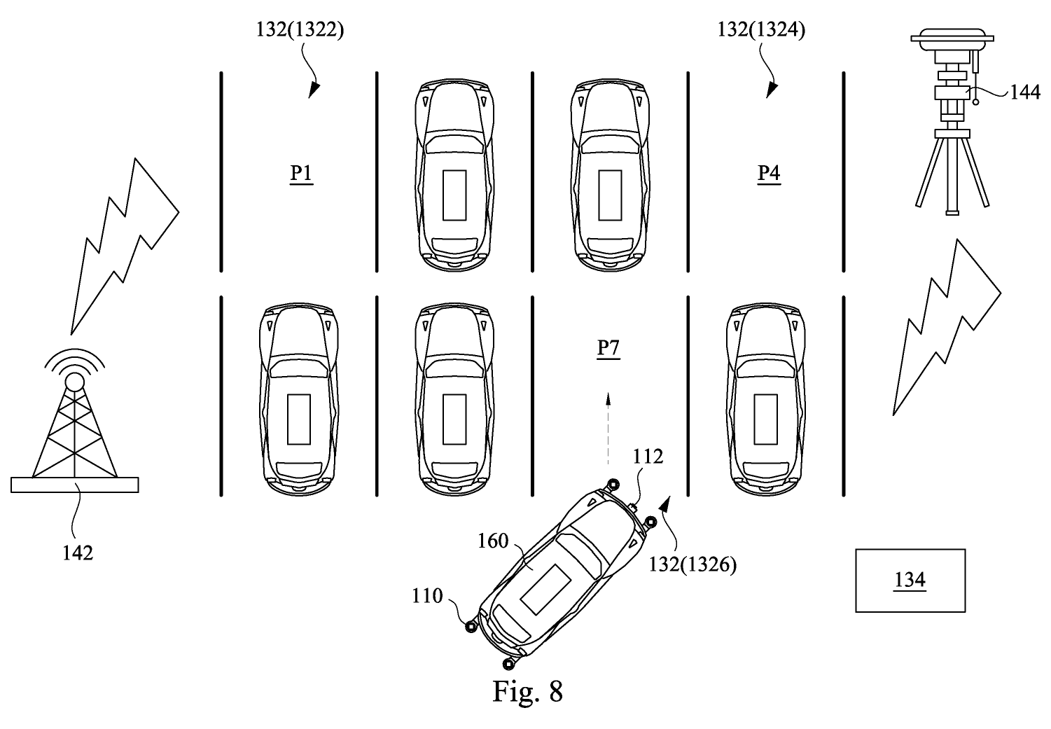

Reference is made to FIG. 6 and FIG. 8. FIG. 8 is a schematic of an intermediate step of the operation method 200 of the automatic towing system 100 in FIG. 6. The operation method 200 continues to step S6, where the towing robot 110 automatically moves the vehicle 160 to one of the parking spaces 1326 available for parking according to the coordinates. In some embodiments, the towing robot 110 automatically navigates to the side of the parking space 1326 and moves the vehicle 160 into the parking space 1326 by using the automatic driving technology to avoid collision with other vehicles 160.

The operation method 200 continues to step S7, the towing robot 110 transmits parking information back to the data processing module 150 through the wireless communication module 116. In this step, the towing robot 110 moves the vehicle 160 into the parking space 1326 and then the towing robot 110 moves out from the bottom of the vehicle 160. The towing robot 110 detects the parking status of the vehicle 160 through the camera 112 and the controller 114, and transmits parking information including the parking space 1326 where the vehicle 160 is located and the parking time back to the data processing module 150. In some embodiments, the towing robot 110 moves to the standby area 134 to wait for subsequent instructions.

Through the operations of the above steps S5 to S7, the vehicle 160 can be driven into the parking space 132 of the vehicle storage area 130 without human effort, thereby simplifying the human resource and the procedure of moving the vehicle 160 into the vehicle storage area 130.

The operation method 200 continues to step S8, where the data processing module 150 transmits the vehicle pickup information to the towing robot 110. In this step, when the owner goes to the vehicle storage area 130 to pick up the vehicle 160, the towing robot 110 automatically performs the vehicle pickup operation. The owner only needs to wait at the exit of the vehicle storage area 130 after complete the vehicle pickup procedure.

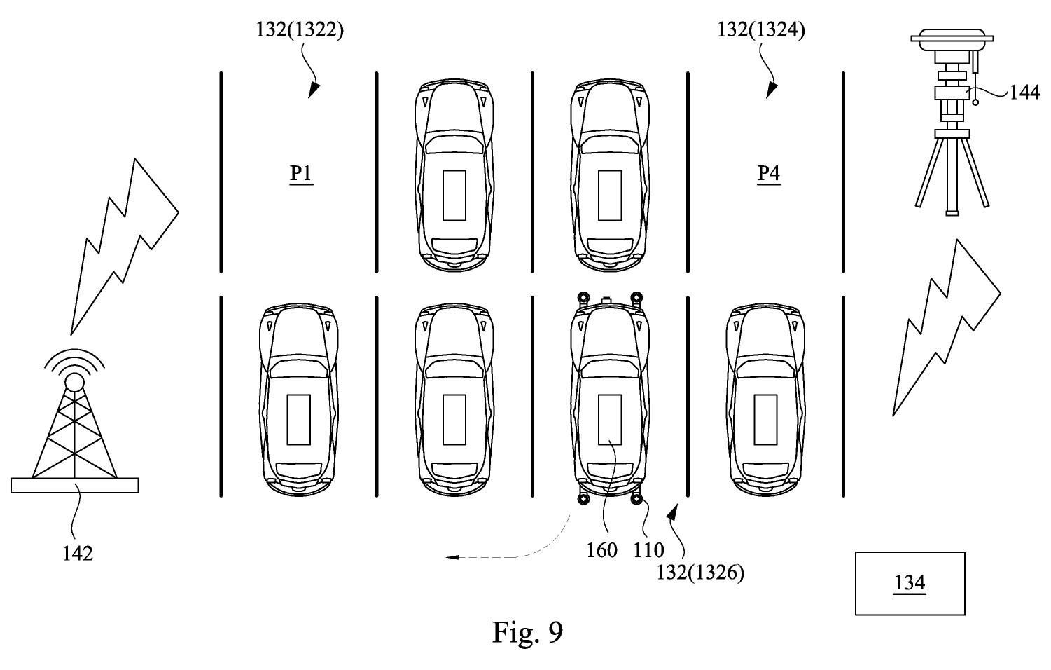

Reference is made to FIG. 6 and FIG. 9. FIG. 9 is a schematic of an intermediate step of the operation method 200 of the automatic towing system 100 in FIG. 6. The operation method 200 continues to step S9, the towing robot 110 moves the vehicle located at the coordinate out to the exit of the vehicle storage area 130 according to the vehicle pickup information. Through the operations of the above steps S8 to S9, the vehicle owner does not need to enter the vehicle storage area 130 to drive the vehicle 160 out, which can simplify the human resource and the procedure of moving the vehicle 160 out of the vehicle storage area 130.

In summary, the towing robot can automatically move to the bottom of the illegally parked vehicle and lift up the vehicle, and move the vehicle out of the illegal parking area. Therefore, there is no need to reserve space in the front and the rear of the location of the vehicle for the towing truck to tow, which can solve the problem of insufficient space. There is no need to use human effort to drive the vehicle into the parking space of the vehicle storage area, which can simplify the human resource and the process of moving the vehicle into the vehicle storage area. The owner does not need to enter the vehicle storage area to drive the vehicle out, which can simplify the human resource and the process of moving the vehicle out of the vehicle storage area.

Although the present invention has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

What is claimed is:

1. An automatic towing system, applied to move a vehicle, wherein the automatic towing system comprises:
a towing robot configured to move the vehicle, wherein the towing robot comprises:
a camera configured to detect a position of the vehicle and an environment of the vehicle; and
a towing arm; and
a towing truck configured to engage with the towing arm of the towing robot.

2. The automatic towing system of claim 1, wherein the towing truck comprises a plurality positioning points, and the camera of the towing robot is configured to detect the positioning points.

3. The automatic towing system of claim 2, wherein the towing robot further comprises a controller configured to calculate a distance between the towing truck and the towing robot based on a coordinate of the positioning points of the towing truck detected by the camera.

4. The automatic towing system of claim 3, wherein the towing truck further comprises a traction arm configured to engage with the tow arm of the towing robot, wherein the camera and the controller of the towing robot are further configured to analyze the position of the towing arm.

5. The automatic towing system of claim 3, wherein the controller of the towing robot has an autonomous driving technology.

6. The automatic towing system of claim 1, further comprising:
a vehicle storage area comprising a plurality of parking spaces; and
a global positioning system disposed in the vehicle storage area and is configured to measure a coordinates of the parking spaces.

7. The automatic towing system of claim 6, wherein the vehicle storage area further comprises:
a standby area configured to park the towing robot.

8. The automatic towing system of claim 6, further comprising:
a data processing module electrically connected to the global positioning system, wherein the data processing module is configured to record the coordinates of the parking spaces measured by the global positioning system.

9. The automatic towing system of claim 8, wherein the towing robot further comprises a wireless communication module configured to transmit parking information to the data processing module.

10. The automatic towing system of claim 8, wherein the data processing module is configured to transmit vehicle pickup information to the towing robot.

11. An operation method of an automatic towing system, applied in an automatic towing system and configured to move a first vehicle, wherein the operation method of the automatic towing system comprises:
lifting up and moving the first vehicle by a towing robot;
detecting a position of a towing truck by a camera and a controller of the towing robot; and
engaging the towing robot with the a traction arm of the towing truck through a tow arm of the towing robot.

12. The operation method of the automatic towing system of claim 11, further comprising:
detecting a position of the first vehicle and an environment in which the first vehicle is located through the camera of the towing robot.

13. The operation method of the automatic towing system of claim 11, wherein detecting the position of the towing truck by the camera and the controller of the towing robot further comprises:
detecting a plurality of positioning points of the towing truck through the camera of the towing robot.

14. The operation method of the automatic towing system of claim 11, further comprising:
calculating a distance between the towing truck and the towing robot according to an image coordinate of the plurality of positioning points of the towing truck detected by the camera through the controller of the towing robot.

15. The operation method of the automatic towing system of claim 14, wherein engaging the towing robot with the traction arm of the towing truck through the towing arm of the towing robot further comprises:
analyzing the position of the traction arm by the camera and the controller of the towing robot.

16. The operation method of the automatic towing system of claim 11, further comprising:
transmitting a first coordinate of a parking space to the towing robot by a global positioning system installed in a vehicle storage area; and
moving the first vehicle to the parking space according to the first coordinate through the towing robot.

17. The operation method of the automatic towing system of claim 16, wherein moving the first vehicle to the parking space according to the first coordinate through the towing robot further comprises:
moving the first vehicle to the parking space by using an automatic driving technology through the towing robot.

18. The operation method of the automatic towing system of claim 17, further comprising:
transmitting parking information back to a data processing module through a wireless communication module by the towing robot.

19. The operation method of the automatic towing system of claim 16, further comprising:
after the towing robot moves to the parking space according to the first coordinate, the towing robot moves to a standby area.

20. The operation method of the automatic towing system of claim 16, further comprising:
transmitting a vehicle pickup information to the towing robot through a data processing module; and
moving a second vehicle located at a second coordinate to an exit of the vehicle storage area according to the second coordinate of the vehicle pickup information through the towing robot.
